(19) United States
(12) Patent Application Publication
(10) Pub. No.: US 2026/0321697 A1
(43) Pub. Date: Oct. 15, 2026

(54) POLYELECTROLYTE MEMBRANE, FUEL CELL STACK, CELL VOLTAGE ACQUIRER, AND METHOD FOR DETECTING ABNORMALITY IN CELL VOLTAGES

(71) Applicant: HONDA MOTOR CO., LTD., Tokyo (JP)

(72) Inventor: Hiroaki TAKITA, Saitama (JP)

(21) Appl. No.: 19/461,723

(22) Filed: Jan. 28, 2026

(30) Foreign Application Priority Data
Jan. 29, 2025 (JP) 2025-013018

(51) Int. Cl. H01M 8/1067; H01M 8/04537

(52) U.S. Cl. CPC H01M 8/1067; H01M 8/04559; H01M 2250/20

(57) ABSTRACT

To provide a polyelectrolyte membrane that can increase abnormality detection accuracy. A polyelectrolyte membrane 50 is intended for a fuel cell and includes a reinforcing member 22 containing a material having PTC characteristics and ionomer layers 24, 26 respectively applied to both surfaces of the reinforcing member 22.

This application is based on and claims the benefit of priority from Japanese Patent Application No. 2025-013018, filed on 29 Jan. 2025, the content of which is incorporated herein by reference.

### BACKGROUND OF THE INVENTION

### Field of the Invention

The present invention relates to a polyelectrolyte membrane for a fuel cell, a fuel cell stack, a cell voltage acquirer, and a method for detecting an abnormality in cell voltages.

### Related Art

In recent years, research and development concerning fuel cells that contribute to higher energy efficiency has been performed in order to ensure access to affordable, reliable, sustainable, and advanced energy for more people.

A problem in the research and development of fuel cells is to reduce degradation of cells due to the cells coming to have negative voltages with restricted supply of hydrogen or air. In relation to reduction of such degradation, Japanese Unexamined Patent Application, Publication No. 2009-283138 discloses a technology for, in a case in which a minimum cell voltage of one power generation cell in a cell stack is in a negative voltage region, stopping extraction of a current from the cell stack.

Patent Document 1: Japanese Unexamined Patent Application, Publication No. 2009-283138

### SUMMARY OF THE INVENTION

In a technology related to fuel cells, a configuration is conceivable in which one voltage detection circuit is provided for a plurality of cells for purposes such as cost cutting. However, this configuration has a problem in that a margin between a voltage value determined to be abnormal and a voltage value determined to be normal cannot be ensured sufficiently, resulting in low accuracy of abnormality detection.

Therefore, in order to solve the above-described problems, the present application has an object to provide a polyelectrolyte membrane that can increase accuracy of abnormality detection. This, in turn, contributes to higher energy efficiency.
(1) A polyelectrolyte membrane for a fuel cell, the polyelectrolyte membrane including:
   a reinforcing member containing a material having PTC characteristics; and
   an ionomer applied to both surfaces of the reinforcing member.

According to the above-described polyelectrolyte membrane, the membrane increases in resistance because of a temperature rise when a cell voltage drops, as the polyelectrolyte membrane has the PTC characteristics. Thus, an overcurrent can be reduced to protect the polyelectrolyte membrane.
(2) The polyelectrolyte membrane according to (1), in which
   the PTC characteristics
   have conductivity in a first temperature range less than or equal to a predetermined temperature, and
   become substantially non-conductive in a second temperature range greater than or equal to the predetermined temperature, and
   the predetermined temperature is a temperature corresponding to a temperature at which breakdown of the polyelectrolyte membrane is started.

According to the above-described polyelectrolyte membrane, the polyelectrolyte membrane has a characteristic of increasing a resistance value at a temperature greater than or equal to the temperature at which dielectric breakdown is started or less than or equal to the temperature and greater than or equal to a temperature in the neighborhood of the temperature. Thus, the effect of protecting the polyelectrolyte membrane can be increased.
(3) The polyelectrolyte membrane according to (1) or (2), in which the reinforcing member contains a composite material of PVDF and Ni.

According to the above-described polyelectrolyte membrane, the PTC characteristics according to (2) can easily be achieved.
(4) A fuel cell stack including a plurality of power generation cells that are stacked, the plurality of power generation cells each having an electrolyte membrane including the polyelectrolyte membrane according to any one of (1) to (3), an electrode structural body, and a separator.

According to the above-described fuel cell stack, a fuel cell stack in which dielectric breakdown due to polarity inversion is unlikely to occur can be obtained.
(5) A cell voltage acquirer for acquiring voltages of the power generation cells in the fuel cell stack according to (4),
   the cell voltage acquirer being solely provided with respect to the plurality of power generation cells.

According to the above-described cell voltage acquirer, the number of cell voltage acquirers can be reduced to achieve cost cutting. In addition, a fuel cell system can be simplified in structure.
(6) The cell voltage acquirer according to (5), in which the cell voltage acquirer acquires a total value of cell voltages of the plurality of power generation cells.

According to the above-described cell voltage acquirer, an abnormality in the power generation cells can be determined by simple arithmetic processing.
(7) A method for detecting an abnormality in cell voltages through use of the cell voltage acquirer according to (5) or (6), including concluding that, when cell voltages acquired by the cell voltage acquirer are smaller in value than a voltage in a case in which one of the plurality of power generation cells is abnormal and the other power generation cells of the plurality of power generation cells are normal, an abnormality has occurred in any of the plurality of power generation cells. A voltage threshold in the case in which the one of the plurality of power generation cells is abnormal is set at a voltage at which dielectric breakdown does not occur in a case in which the polyelectrolyte membranes of the plurality of power generation cells are composed of a material having the PTC characteristics, or at a voltage at which dielectric breakdown occurs in a case in which the polyelectrolyte membranes of the plurality of power generation cells are composed of a material not having the PTC characteristics.

According to the above-described method for detecting an abnormality in cell voltages, a large margin can be ensured between abnormality and normality in abnormality detection.

According to the present invention, a polyelectrolyte membrane that can increase abnormality detection accuracy can be provided.

### BRIEF DESCRIPTION OF THE DRAWINGS

FIG. 1 is a cross-sectional view of a polyelectrolyte membrane of an embodiment of the present invention;

FIG. 2 is a block diagram showing a configuration of a fuel cell system of the embodiment of the present invention;

FIG. 3 shows a relationship between cell voltage of a power generation cell and electrolyte membrane temperature; and

FIG. 4 shows a temporal change of a minimum cell voltage when an abnormality occurs, and the like.

### DETAILED DESCRIPTION OF THE INVENTION

### Polyelectrolyte Membrane

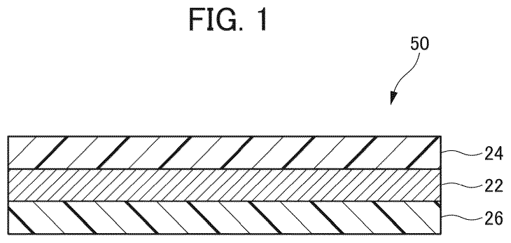

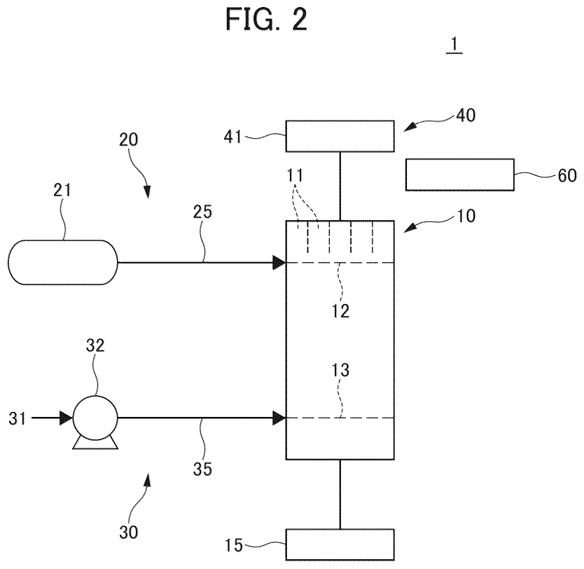

A polyelectrolyte membrane 50 of an embodiment of the present invention will be described with reference to FIG. 1. FIG. 1 is a cross-sectional view of the polyelectrolyte membrane 50. The polyelectrolyte membrane 50 is an electrolyte membrane included in a power generation cell 11 constituting a fuel cell stack 10. The polyelectrolyte membrane 50 is an electrolyte membrane for a fuel cell. The fuel cell stack 10 and the power generation cell 11 will be described later with reference to FIG. 2. The polyelectrolyte membrane may be simply described as an electrolyte membrane.

The polyelectrolyte membrane 50 includes a reinforcing member 22, an ionomer layer 24, and an ionomer layer 26. The reinforcing member 22 is sandwiched between the ionomer layer 24 and the ionomer layer 26. The ionomer layers may also be referred to as proton exchange layers or electrolyte layers.

### Temperature Characteristics of Resistance of Reinforcing Member

In the polyelectrolyte membrane 50 of the present embodiment, the reinforcing member 22 contains a material having PTC characteristics. The PTC (Positive Temperature Coefficient) characteristics mean temperature characteristics in which electric resistance increases with a rise in temperature. In the polyelectrolyte membrane 50 of the present embodiment, the reinforcing member 22 contains a material having the PTC characteristics. Thus, because of a temperature rise when the cell voltage drops, the reinforcing member 22 increases in resistance, and in turn, the polyelectrolyte membrane 50 increases in resistance. This reduces flowing of an overcurrent, as a result of which the polyelectrolyte membrane 50 can be protected.

### First Temperature Range and Second Temperature Range

It is preferable that the PTC characteristics of the reinforcing member 22 should have conductivity in a first temperature range less than or equal to a predetermined temperature and should become substantially non-conductive in a second temperature range greater than or equal to the predetermined temperature. The predetermined temperature is a temperature corresponding to a temperature at which breakdown of the polyelectrolyte membrane 50 is started. The temperature corresponding to the temperature at which breakdown of the polyelectrolyte membrane 50 is started means the temperature at which breakdown of the polyelectrolyte membrane 50 is started and a temperature in the neighborhood of the temperature and lower than the temperature.

When the PTC characteristics of the reinforcing member 22 have characteristics of increasing a resistance value at a temperature greater than or equal to the temperature at which breakdown of the polyelectrolyte membrane 50 is started or a temperature slightly below the temperature, the polyelectrolyte membrane 50 can be protected more reliably.

Usually, the polyelectrolyte membrane 50 rises in temperature with a drop in cell voltage. In this case, the polyelectrolyte membrane 50 can be protected more reliably when the reinforcing member 22 increases in resistance value from a time point before the temperature of the polyelectrolyte membrane 50 reaches the temperature at which breakdown of the polyelectrolyte membrane 50 is started.

This is because the temperature can be prevented more reliably from reaching the temperature at which breakdown is started by reducing a further temperature rise before reaching the temperature at which breakdown is started.

### Material of Reinforcing Member

The material of the reinforcing member 22 may contain a composite material of Poly Vinylidene Fluoride (PVDF) and Ni, for example. PVDF serves as a base polymer in the conductive composite material forming the reinforcing member 22. Ni functions as a conductive filler. The conductive composite material can be formed from PVDF and Ni by the following method, for example. First, a pellet of PVDF is fused, and a filler of Ni is introduced therein. Thereafter, the composite material of PVDF and Ni is kneaded, and is hot-pressed using a mold. Thereafter, the composite material is cooled naturally together with the mold, so that the reinforcing member 22 composed of the composite material of PVDF and Ni can be obtained.

When the material of the reinforcing member 22 is the composite material of PVDF and Ni, the reinforcing member 22 having desired PTC characteristics can easily be obtained.

### Method for Manufacturing Polyelectrolyte Membrane

A method for manufacturing the polyelectrolyte membrane 50 will be described. The polyelectrolyte membrane 50 can be manufactured by applying an ionomer to both surfaces of the reinforcing member 22. Layers composed of the applied ionomer are the ionomer layer 24 and the ionomer layer 26. Examples of the ionomer can include a perfluoro sulfonic acid ionomer and a hydrocarbon ionomer. For applying the ionomer to the reinforcing member 22, a conventional method can be used.

### Configuration of Fuel Cell System

A fuel cell system 1 according to the present embodiment will be described with reference to FIG. 2. FIG. 2 is a block diagram showing a schematic configuration of the fuel cell system 1. The fuel cell system 1 includes the fuel cell stack 10, a cell voltage acquirer 15, an anode system 20, a cathode system 30, a power-consuming system 40, and a control device 60.

### Fuel Cell Stack

The fuel cell stack 10 includes a plurality of the power generation cells 11 that are stacked. What is called a solid polymer cell can be used for the power generation cell 11. The plurality of power generation cells 11 are electrically connected in series to one another. The number of the power generation cells 11 to be stacked in the one fuel cell stack 10 can be more than or equal to 200 and less than or equal to 400, for example.

### Power Generation Cell

The power generation cell 11 includes a membrane-electrode joined body (not shown), an anode separator (not shown), and a cathode separator (not shown). The anode separator and the cathode separator are arranged to sandwich the membrane-electrode joined body. The anode separator and the cathode separator each have conductivity. The anode separator and the cathode separator will be collectively referred to as a separator.

### Membrane-Electrode Joined Body

The membrane-electrode joined body includes the polyelectrolyte membrane 50 (shown in FIG. 1) and an electrode structural body (not shown). The polyelectrolyte membrane 50 includes a solid polymer membrane. The electrode structural body includes an anode and a cathode.

### Polyelectrolyte Membrane

The polyelectrolyte membrane 50 of the present embodiment includes the reinforcing member 22, the ionomer layer 24, and the ionomer layer 26 as described earlier with reference to FIG. 1. The reinforcing member 22 contains a material having the PTC characteristics.

### Electrode Structural Body

The electrode structural body includes a catalyst for causing an electrode reaction in the anode and the cathode, in addition to the anode and the cathode. The catalyst can be Pt or Ru, for example. The electrode structural body may include a gas diffusion layer or the like.

### Anode Separator

An anode flow path 12 is formed in the anode separator. The anode flow path 12 functions as a fuel gas flow path.

### Cathode Separator

A cathode flow path 13 is formed in the cathode separator. The cathode flow path 13 functions as an oxidant gas flow path.

As described above, the polyelectrolyte membrane of the present embodiment includes the reinforcing member containing the material having the PTC characteristics and the ionomer applied to both the surfaces of the reinforcing member. The fuel cell stack 10 of the present embodiment includes a plurality of the power generation cells that are stacked, each having an electrolyte membrane including the polyelectrolyte membrane, the electrode structural body, and the separator. Thus, with the fuel cell stack 10 of the present embodiment, a fuel cell stack in which dielectric breakdown due to polarity inversion is unlikely to occur can be obtained. The dielectric breakdown will be described later.

### Anode System

A system of supplying/exhausting hydrogen to/from the anode will be referred to as the anode system 20. The anode system 20 includes a hydrogen tank 21 and an anode pipe 25. The anode pipe 25 is connected to the anode flow path 12.

### Cathode System

A system of supplying/exhausting oxygen to/from the cathode will be referred to as the cathode system 30. The cathode system 30 includes a compressor 32 and a cathode pipe 35. Air 31 is supplied to the cathode pipe 35 via the compressor 32. The cathode pipe 35 is connected to the cathode flow path 13.

### Power-Consuming System

A system of consuming power generated by the fuel cell stack 10 will be referred to as the power-consuming system 40. The power-consuming system 40 includes power-consuming equipment 41 such as a traction motor and a battery of a vehicle, for example. A current extracted from the fuel cell stack 10 to the power-consuming system 40 is defined as a command current.

### Control Device

The control device 60 is a device that controls actuation of the fuel cell system 1. The control device 60 can control actuation of the whole fuel cell system 1 based on cell voltages acquired by the cell voltage acquirer 15 which will be described below and the like. The control device 60 may execute various types of processing in accordance with a program stored therein, for example, to control various types of equipment included in the fuel cell system 1.

The control device 60 may determine, based on a minimum cell voltage input from the cell voltage acquirer 15, for example, whether or not the minimum cell voltage is in a negative voltage region, whether or not the minimum cell voltage has escaped from the negative voltage region, or the like. The various types of equipment in the fuel cell system 1 may be controlled in accordance with a result of the determination. Note that the minimum cell voltage indicates a minimum cell voltage among cell voltages acquired in the fuel cell stack 10.

### Cell Voltage Acquirer

The cell voltage acquirer 15 is equipment for acquiring cell voltages of the plurality of power generation cells 11 constituting the fuel cell stack 10. The cell voltage acquirer 15 scans the power generation cells 11 in a predetermined cycle, for example. The cell voltage acquirer 15 can then acquire the cell voltages of the respective power generation cells 11 and calculate the minimum cell voltage. The cell voltage acquirer 15 can also output the calculated minimum cell voltage to the control device 60.

A reaction in the power generation cells 11 and the like will be described. When hydrogen is supplied to each anode through the anode flow path 12, an electrode reaction in Expression (1) occurs. When air is supplied to each cathode via the cathode flow path 13, an electrode reaction in Expression (2) occurs. Accordingly, potential differences arise among the respective power generation cells 11.

2H₂→4H++4e⁻ (1)

O₂+4H++4e⁻→2H₂O (2)

When the fuel cell stack 10 and the power-consuming system 40, such as the traction motor, are electrically connected and a current is extracted, the fuel cell stack 10 subsequently generates power.

### Deficiency in Hydrogen

A necessary amount of hydrogen is not supplied to the anode in some cases due to an influence of moisture, for example. That is, the power generation cell 11 becomes deficient in hydrogen in some cases. When there is a deficiency in hydrogen, a voltage of the power generation cell 11, that is, the cell voltage, tends to drop.

### Drop in Cell Voltage

In a case in which the cell voltages of some of the power generation cells 11 drop and in which the power generation cells 11 on both sides of the power generation cells 11 concerned are normal, voltages are applied to the power generation cells 11 dropped in cell voltage from the normal power generation cells 11 on both the sides. As a result, the cell voltages of these power generation cells 11 may drop to become a negative voltage.

When the cell voltages drop and an overcurrent flows to the polyelectrolyte membrane 50, the polyelectrolyte membrane 50 rises in temperature due to a factor such as heat generated when the current flows, so that the polyelectrolyte membrane 50 might be broken down.

In the state of a deficiency in hydrogen, a water electrolysis reaction occurs in the anode rather than the reaction in (1) above. As a result, the anode catalyst might be decomposed to impair the function of the anode.

Therefore, a drop in cell voltage is detected by the cell voltage acquirer 15. The control device 60 then performs current control in the fuel cell system 1 in accordance with the minimum cell voltage acquired by the cell voltage acquirer 15.

The current control can be performed in multiple stages, for example. Hereinafter, an example of a case in which the current control is performed in two stages will be described. A first voltage value and a second voltage value are set in advance as minimum cell voltages at which predetermined current control is started.

### First Voltage Value and Current Limitation

A voltage at which it is concluded that the minimum cell voltage is in a negative voltage region when the minimum cell voltage drops to this voltage or below and at which it is concluded that the command current should be set at 0 A is defined as the first voltage value. Note that the negative voltage region is a region in which the potential at the anode of the power generation cell 11, which should usually be lower, becomes higher than the potential at the cathode. In a case in which it is concluded that the minimum cell voltage acquired by the cell voltage acquirer 15 drops to the first voltage value, the control device 60 sets the command current at 0 A. That is, there is no power supply to the power-consuming equipment 41. As described, a current to an external load is limited when the minimum cell voltage drops to the first voltage value.

### Second Voltage Value and Stop of Power Generation

A voltage at which the electrolyte membrane of the power generation cell 11 decomposes when the minimum cell voltage drops to this voltage or below is defined as the second voltage value. The second voltage value is lower than the first voltage value. The second voltage value will also be referred to as a breakdown voltage. In a case in which it is concluded that the minimum cell voltage acquired by the cell voltage acquirer 15 drops to the second voltage value, the control device 60 cuts off an electric connection between the fuel cell stack 10 and the power-consuming system 40. For example, the power-consuming equipment 41, which is an external load such as the traction motor, and the fuel cell stack 10 are disconnected. That is, power generation is stopped when the minimum cell voltage drops to the second voltage value, or more strictly saying, before the minimum cell voltage drops to the second voltage value.

### Thermal Decomposition of Electrolyte Membrane and Cell Voltage

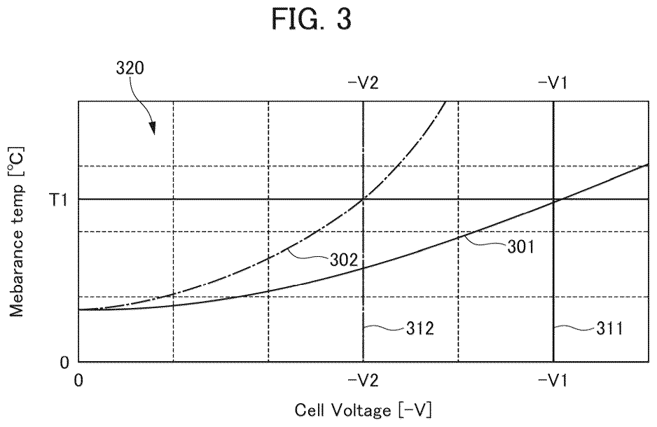

FIG. 3 shows a relationship between cell voltage of the power generation cell 11 and electrolyte membrane temperature. The horizontal axis of the graph shown in FIG. 3 indicates the cell voltage (−V). The vertical axis indicates the electrolyte membrane temperature (°C). A temperature characteristic of the electrolyte membrane of the present embodiment is defined as a first temperature characteristic 301. A temperature characteristic of a conventional electrolyte membrane is defined as a second temperature characteristic 302. FIG. 3 shows the first temperature characteristic 301 and the second temperature characteristic 302.

A region in which the electrolyte membrane thermally decomposes is defined as a thermal decomposition region 320. The thermal decomposition region 320 is a temperature region greater than or equal to a thermal decomposition temperature of the electrolyte membrane. FIG. 3 shows the thermal decomposition region 320. In the example shown in FIG. 3, the thermal decomposition temperature of the electrolyte membrane is T1. T1, which is the thermal decomposition temperature, is a temperature at which the ionomer layer 24 or the ionomer layer 26 in the electrolyte membrane is broken down by thermal decomposition.

In the electrolyte membrane of the present embodiment, a cell voltage at which the electrolyte membrane temperature becomes T1, which is the thermal decomposition temperature, is −V1 as indicated by the first temperature characteristic 301. The cell voltage at which the temperature of the electrolyte membrane of the present embodiment becomes the thermal decomposition temperature is defined as a first dielectric breakdown limit voltage 311.

On the other hand, in the conventional electrolyte membrane, the cell voltage at which the electrolyte membrane temperature becomes T1 is −V2 as indicated by the second temperature characteristic 302. The cell voltage at which the temperature of the conventional electrolyte membrane becomes the thermal decomposition temperature is defined as a second dielectric breakdown limit voltage 312.

In the electrolyte membrane of the present embodiment, the reinforcing member contains a material having the PTC characteristics. Thus, in the electrolyte membrane of the present embodiment, an overcurrent does not flow, as the whole electrolyte membrane increases in resistance value even if the cell voltage drops to raise the electrolyte membrane temperature. As a result, the electrolyte membrane temperature is unlikely to rise even if the cell voltage drops. That is, a rise in electrolyte membrane temperature in association with a drop in cell voltage is smaller than in the conventional electrolyte membrane indicated by the second temperature characteristic 302. Thus, in the electrolyte membrane of the present embodiment, the cell voltage at which the electrolyte membrane temperature becomes the thermal decomposition temperature is lower than in the conventional electrolyte membrane.

On the other hand, in the conventional electrolyte membrane, a rise in electrolyte membrane temperature in response to a drop in cell voltage is steeper than in the electrolyte membrane of the present embodiment. This is because the reinforcing member does not have the PTC characteristics. Thus, in the conventional electrolyte membrane, the electrolyte membrane temperature becomes the thermal decomposition temperature at a cell voltage higher than in the electrolyte membrane of the present embodiment.

As described above, in the electrolyte membrane of the present embodiment, the use of the electrolyte membrane having the material having the PTC characteristics that rises in resistance value relying on a rise in temperature can prevent the electrolyte membrane temperature from reaching the dielectric breakdown temperature even if the cell voltage drops below −V2.

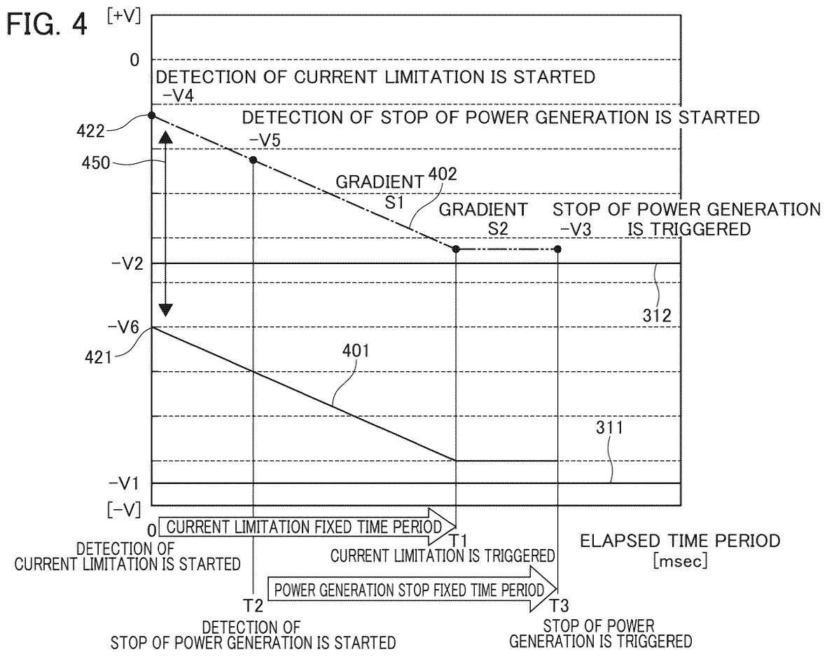

Abnormal detection and prevention of electrolyte membrane breakdown will be described with reference to FIG. 4. FIG. 4 shows a temporal change in minimum cell voltage when an abnormality occurs, and the like. The horizontal axis of the graph shown in FIG. 4 indicates the elapsed time (msec). The vertical axis indicates the minimum cell voltage (−V) when an abnormality occurs.

First, a conventional abnormality determination and abnormality handling will be described. Note that abnormality detection focuses on detecting an abnormality from cell voltages or the like, for example, and the abnormality determination focuses on determining whether or not a situation is abnormal based on the cell voltages or the like, for example. As described earlier with reference to FIG. 3, the cell voltage at which the electrolyte membrane reaches the thermal decomposition temperature is the dielectric breakdown limit voltage, and the dielectric breakdown limit voltage in the conventional electrolyte membrane is the second dielectric breakdown limit voltage 312. In the following description, the second dielectric breakdown limit voltage 312 shall be −V2 as shown in FIG. 3.

In the example shown in FIG. 4, a cell voltage at which stop of power generation is triggered is set at −V3 taking into consideration safety for −V2, which is the second dielectric breakdown limit voltage 312.

A time period is required until stop of power generation is triggered after an abnormality or a sign of an abnormality is detected. That is, there is a time lag until stop of power generation is triggered after an abnormality or a sign of an abnormality is detected and stop of power generation is commanded.

The cell voltage drops during this time lag. Thus, the cell voltage at which an abnormality is detected needs to be set at a value taking into consideration a drop in cell voltage during the time lag. The cell voltage at which an abnormality is detected is defined as a threshold voltage. A conventional threshold voltage is defined as a second threshold voltage 422. FIG. 4 shows the second threshold voltage 422 at −V4.

### Current Limitation and Stop of Power Generation

A flow from detection of an abnormality to abnormality handling will be described more specifically. Abnormality handling includes current limitation and stop of power generation. The content of current limitation and stop of power generation has been described earlier. The current limitation and stop of power generation are performed in this order.

In the conventional example shown in FIG. 4, T1 elapses between the start of detection of current limitation and triggering of current limitation. That is, a current limitation fixed time period is T1. During this period, the cell voltage declines with a gradient S1.

In the conventional example shown in FIG. 4, T1 elapses between the start of detection of stop of power generation and triggering of stop of power generation. That is, a power generation stop fixed time period is T1. In a time period overlapped on the current limitation fixed time period during the power generation stop fixed time period, the cell voltage declines with the gradient S1. In a time period after the end of the current limitation fixed time period during the power generation stop fixed time period, the cell voltage declines with a gradient S2.

In the example shown in FIG. 4, detection of stop of power generation is started at a time point when T2 elapses after detection of current limitation is started. The stop of power generation is triggered at a time point when T3 elapses after detection of current limitation is started. Thus, the cell voltage declines with the gradient S2 between T1 at which current limitation is triggered and T3 at which stop of power generation is triggered.

The decline in cell voltage as described above is shown as a second voltage drop line 402 in FIG. 4. The cell voltage at which detection of current limitation is started is decided by tracking back the second voltage drop line 402 from when stop of power generation is triggered. In the example shown in FIG. 4, the cell voltage at which detection of current limitation is started is −V4. This cell voltage, at which detection of current limitation is started, is the second threshold voltage 422. In the example shown in FIG. 4, the cell voltage at which detection of stop of power generation is started is −V5.

As described above, in the conventional electrolyte membrane, the cell voltage at which detection of current limitation is started, that is, the threshold voltage, is set at −V4 such that the cell voltage when the stop of power generation is triggered does not fall below −V2.

Next, a threshold voltage in the electrolyte membrane of the present embodiment will be described. In the following description, matters different from the threshold voltage in the conventional electrolyte membrane described above will be mainly described.

The first dielectric breakdown limit voltage 311, which is the dielectric breakdown limit voltage in the electrolyte membrane of the present embodiment, is set at −V1 as shown earlier in FIG. 3.

In the example shown in FIG. 4, the cell voltage at which stop of power generation is triggered is set at a voltage higher than −V1 taking into consideration safety for −V1, which is the first dielectric breakdown limit voltage 311.

The time period between an abnormality determination and stop of power generation, the gradient of a decline in cell voltage during that period, and the like in the present embodiment shall be the same as those in the case of the conventional electrolyte membrane. FIG. 4 shows the decline in cell voltage in the electrolyte membrane of the present embodiment as a first voltage drop line 401. A tendency of change in the first voltage drop line 401 is the same as the tendency of change in the second voltage drop line 402.

The cell voltage at which detection of current limitation is started is decided by tracking back the first voltage drop line 401 from when stop of power generation is triggered, similarly to the case of the conventional electrolyte membrane. In the example shown in FIG. 4, the cell voltage at which detection of current limitation is started is −V6. This cell voltage, at which detection of current limitation is started, is a first threshold voltage 421.

As described above, in the electrolyte membrane of the present embodiment, the cell voltage at which detection of current limitation is started, that is, the threshold voltage, is set at −V6 such that the cell voltage when the stop of power generation is triggered does not fall below −V1.

In the polyelectrolyte membrane 50 of the present embodiment, the reinforcing member 22 contains the material having the PTC characteristics. Thus, the first dielectric breakdown limit voltage 311 drops. The first threshold voltage 421 drops when the first dielectric breakdown limit voltage 311 drops. This can reduce an occurrence of a false determination in the abnormality determination of the fuel cell system 1 based on a result of acquisition of the cell voltage acquirer 15, in particular, the minimum cell voltage. In particular, a false determination can be reduced in the configuration in which the one cell voltage acquirer 15 is provided for a plurality of power generation cells. Hereinafter, specific description will be given.

First, voltage detection in a power generation cell including the conventional electrolyte membrane will be described. As described with reference to FIG. 4, the second threshold voltage 422, which is the threshold of conventional voltage detection, shall be −V4.

A case in which one cell voltage acquirer is provided for one power generation cell will be described. Assume that the voltage value acquired by the cell voltage acquirer by scanning the power generation cell is a negative value. In this case, since the voltage value is a negative value, it can be determined that the power generation cell has an abnormality. In the case in which one cell voltage acquirer is provided for one power generation cell, a correct determination can be made. This is because the acquired voltage value can be specified as a voltage value of the power generation cell targeted for acquisition. In this case, even if the acquired voltage value is a value higher than −V4, it can be determined that the power generation cell has an abnormality, as the voltage value is a negative value.

Next, a case in which one cell voltage acquirer is provided for two power generation cells will be described. Assume that an average value of cell voltages acquired by the cell voltage acquirer by scanning the power generation cells is a negative value. In this case, since the voltage value is a negative value, it can be determined that at least one of the two power generation cells has an abnormality. For example, it is determined that one of the power generation cells is normal and that the other power generation cell is abnormal. In a case in which an absolute value of the voltage of the normal cell is smaller than an absolute value of the voltage of the abnormal cell, a total value of cell voltages of the two power generation cells becomes a negative value. The average value of the cell voltages also becomes a negative value. As described above, in the case in which one cell voltage acquirer is provided for two power generation cells, a correct determination can be made with the total value of the cell voltages becoming a negative value or with the average value of the cell voltages becoming a negative value.

Next, a case in which one cell voltage acquirer is provided for three power generation cells will be described. Assume that an average value of cell voltages acquired by the cell voltage acquirer by scanning the power generation cells is a positive value. In this case, since the voltage value is a positive value, it is determined that all the three power generation cells are normal.

In this case, however, two of the three power generation cells may be normal, and one of the power generation cells may have an abnormality. In a case in which the total of absolute values of the voltages of the normal cells is larger than the absolute value of the voltage of the abnormal cell, the total value of the cell voltages of the three power generation cells becomes a positive value. The average value of the cell voltages also becomes a positive value. As described above, in the case in which one cell voltage acquirer is provided for three power generation cells, a correct determination cannot be made with the total value of the cell voltages becoming a negative value or with the average value of the cell voltages becoming a negative value. This is because the total value and the average value of the cell voltages may become positive values even though an abnormal power generation cell is included.

With the conventional power generation cell as described above, in the case in which one cell voltage acquirer is provided for a plurality of power generation cells and in which the plurality of power generation cells are scanned for purposes such as cost cutting, a threshold of abnormality detection needs to be raised so as to prevent a false determination when the power generation cells are increased. However, the threshold of abnormality detection can only be raised to a range not overlapped on the cell voltages of normal power generation cells. Thus, there is a limit on reduction of the number of voltage acquirers by providing one voltage acquirer for a plurality of power generation cells.

On the other hand, an occurrence of a false determination can be reduced in voltage detection for a power generation cell including the electrolyte membrane of the present embodiment.

Description will be given using the case in which one cell voltage acquirer is provided for three power generation cells as an example. In the electrolyte membrane of the present embodiment, the cell voltage of an abnormal power generation cell is lower than in the case of the conventional electrolyte membrane. Since the threshold voltage is low in the present embodiment, a correct abnormality determination is easily performed with the total value of the cell voltages becoming a negative value or with the average value of the cell voltages becoming a negative value even in the case in which one cell voltage acquirer is provided for three power generation cells.

As described, for the power generation cell including the electrolyte membrane of the present embodiment, the total value and the average value of the cell voltages become negative values even in the case in which one cell voltage acquirer is provided for three power generation cells. That is, an occurrence of erroneous detection can be reduced with an abnormal negative voltage being overlapped on a normal positive voltage. As a result, the number of power generation cells that can be detected by one cell voltage acquirer can be increased.

As described above, the cell voltage acquirer 15 of the present embodiment acquires the voltages of the power generation cells 11, and the cell voltage acquirer 15 can be solely provided with respect to the plurality of power generation cells 11.

The cell voltage acquirer 15 can acquire the total value of the cell voltages of the plurality of power generation cells 11. The cell voltage acquirer 15 may also acquire the average value of the cell voltages of the plurality of power generation cells 11.

### Method for Detecting Abnormality in Cell Voltage

A method for detecting an abnormality in cell voltages of the present embodiment will be described. The method for detecting an abnormality in cell voltages of the present embodiment is a method for detecting an abnormality in cell voltages through use of the cell voltage acquirer 15, and includes concluding that, in a case in which cell voltages acquired by the cell voltage acquirer 15 are smaller in value than a total value of voltages in a case in which one of the plurality of power generation cells 11 is abnormal and in which the other power generation cells 11 are normal, an abnormality has occurred in any of the power generation cells 11. A voltage threshold in the case in which the one of the plurality of power generation cells 11 is abnormal is set at a voltage at which dielectric breakdown does not occur in a case in which the polyelectrolyte membranes 50 of the power generation cells 11 are composed of a material having the PTC characteristics or at a voltage at which dielectric breakdown occurs in a case in which the polyelectrolyte membranes 50 of the power generation cells 11 are composed of a material not having the PTC characteristics. Description will be given below.

As mentioned before, the cell voltage acquirer 15 of the present embodiment can be solely provided with respect to the plurality of power generation cells 11. In the case in which the cell voltages acquired by the cell voltage acquirer 15 are smaller in value than the total value of voltages in the case in which one of the plurality of power generation cells 11 is abnormal and in which the other power generation cells 11 are normal, it can be concluded that an abnormality has occurred in any of the power generation cells 11. For example, in the case in which the acquired cell voltages are smaller than a cell voltage value in the case in which one of the three power generation cells 11 is abnormal and in which the remaining two are normal, it can be concluded that at least one of the power generation cells 11 is abnormal, as described earlier.

Herein, the voltage threshold in the conclusion in the case in which one of the power generation cells 11 is abnormal can be set at a value between the first threshold voltage 421 and the second threshold voltage 422 as described earlier with reference to FIG. 4. A range greater than or equal to the second threshold voltage 422 and less than or equal to the first threshold voltage 421 is defined as a threshold setting range 450. FIG. 4 shows the threshold setting range 450. The voltage threshold in the conclusion in the case in which one of the power generation cells 11 is abnormal can be set in the threshold setting range 450.

The threshold setting range 450 can be described as follows. The threshold setting range 450 includes voltages at which dielectric breakdown does not occur in the case in which the polyelectrolyte membrane 50 of the power generation cell 11 is composed of a material having the PTC characteristics and voltages at which dielectric breakdown occurs in the case in which the polyelectrolyte membrane 50 of the power generation cell 11 is composed of a material not having the PTC characteristics.

This is because the second threshold voltage 422 and the first threshold voltage 421 can be translated as follows. In other words, the voltages at which dielectric breakdown does not occur in the case in which the polyelectrolyte membrane 50 of the power generation cell 11 is composed of a material having the PTC characteristics are voltages greater than or equal to the second threshold voltage 422. The voltages at which dielectric breakdown occurs in the case in which the polyelectrolyte membrane 50 of the power generation cell 11 is composed of a material not having the PTC characteristics are voltages less than or equal to the first threshold voltage 421.

From the foregoing, the threshold setting range 450 is a voltage range in which dielectric breakdown does not occur in the case in which the polyelectrolyte membrane 50 has the PTC characteristics and in which dielectric breakdown occurs in the case in which the polyelectrolyte membrane 50 does not have the PTC characteristics.

The method for detecting an abnormality in cell voltages of the present embodiment can ensure a large margin between abnormality and normality in abnormality detection.

As described above, the electrolyte membrane having a material having the PTC characteristics is used in the present embodiment. The use of the material having the PTC characteristics can reduce flowing of an overcurrent, as the material rises in resistance value even if the voltage drops. A material having such PTC characteristics that the resistance value is low at a temperature at which the membrane is not broken down and that the resistance value is high at a temperature at which the membrane is broken down is used for the electrolyte membrane to lower the threshold of the abnormality determination and integrate cell voltage detection circuits for a plurality of cells. As described, in the present embodiment, the voltage value at which the membrane reaches a breakdown temperature can be lowered, as a result of which a margin for the abnormality determination can be ensured even if the voltage detection circuits are integrated.

An embodiment of the present invention has been described above. The present invention is not limited to the aforementioned embodiment and can be changed, modified, and combined variously.

### EXPLANATION OF REFERENCE NUMERALS

1 fuel cell system
10 fuel cell stack
11 power generation cell
15 cell voltage acquirer
22 reinforcing member
24 ionomer layer
26 ionomer layer
40 power-consuming system
41 power-consuming equipment
50 polyelectrolyte membrane

What is claimed is:

1. A polyelectrolyte membrane for a fuel cell, the polyelectrolyte membrane comprising:
a reinforcing member containing a material having PTC characteristics; and
an ionomer applied to both surfaces of the reinforcing member.

2. The polyelectrolyte membrane according to claim 1, wherein the PTC characteristics
have conductivity in a first temperature range less than or equal to a predetermined temperature, and
become substantially non-conductive in a second temperature range greater than or equal to the predetermined temperature, and
the predetermined temperature is a temperature corresponding to a temperature at which breakdown of the polyelectrolyte membrane is started.

3. The polyelectrolyte membrane according to claim 2, wherein the reinforcing member contains a composite material of PVDF and Ni.

4. A fuel cell stack comprising a plurality of power generation cells that are stacked, the plurality of power generation cells each having an electrolyte membrane including the polyelectrolyte membrane according to claim 1, an electrode structural body, and a separator.

5. A cell voltage acquirer for acquiring voltages of the power generation cells in the fuel cell stack according to claim 4,
the cell voltage acquirer being solely provided with respect to the plurality of power generation cells.

6. The cell voltage acquirer according to claim 5, wherein the cell voltage acquirer acquires a total value of cell voltages of the plurality of power generation cells.

7. A method for detecting an abnormality in cell voltages through use of the cell voltage acquirer according to claim 5, the method comprising
concluding that, when cell voltages acquired by the cell voltage acquirer are smaller in value than a voltage in a case in which one of the plurality of power generation cells is abnormal and other power generation cells of the plurality of power generation cells are normal, an abnormality has occurred in any of the plurality of power generation cells, wherein a voltage threshold in the case in which one of the plurality of power generation cells is abnormal is set at a voltage at which dielectric breakdown does not occur in a case in which the polyelectrolyte membranes of the plurality of power generation cells are composed of a material having the PTC characteristics, or at a voltage at which dielectric breakdown occurs in a case in which the polyelectrolyte membranes of the plurality of power generation cells are composed of a material not having the PTC characteristics.
